(19) United States
(12) Patent Application Publication
(10) Pub. No.: US 2014/0199965 A1
(43) Pub. Date: Jul. 17, 2014

(54) PREVENTING UNAUTHORIZED USE OF VEHICLE WIRELESS SERVICES

(71) Applicant: GENERAL MOTORS LLC, Detroit, MI (US)

(72) Inventors: Lawrence D. Cepuran, Northville, MI (US); Steven Swanson, Commerce Township, MI (US)

(73) Assignee: GENERAL MOTORS LLC, Detroit, MI (US)

(21) Appl. No.: 13/739,154

(22) Filed: Jan. 11, 2013

(51) Int. Cl. H04W 12/08

(52) U.S. Cl. CPC H04W 12/08
USPC 455/411

(57) ABSTRACT

A method and system for temporarily disabling vehicle wireless services to prevent a third-party such as a bailee from using one or more vehicle wireless services without authorization. The wireless services may accrue cellular data charges to the vehicle user's account. The method includes configuring a telematics unit to identify a valet event, determining the occurrence of the valet event at the telematics unit, and initiating a valet mode in the vehicle based on the determination. In the valet mode, the vehicle wireless services may be temporarily disabled.

### TECHNICAL FIELD

The present invention relates to receiving vehicle services in a vehicle, and more particularly to preventing the unauthorized use of the vehicle's wireless services.

### BACKGROUND

Vehicles are increasingly designed not only to transport occupant to a destination but also to provide an enjoyable experience at the same time. For instance, the vehicle may receive streaming music, movies, etc. These services may be provided wirelessly to a subscriber/driver at a cost. For example, the subscriber may have a cellular data plan associated with the vehicle which charges the subscriber according to the amount of data the subscriber uses (e.g., by the megabyte or gigabyte).

The driver may leave the vehicle temporarily with a bailee such as a parking attendant, and the parking attendant, without authorization, may listen to the streaming music and/or view the streaming movies (consuming additional cellular data). The driver may be ultimately responsible to pay the charges according to the terms of the data plan.

### SUMMARY

According to an embodiment of the invention, there is provided a method of temporarily disabling one or more wireless services to prevent a third-party from using the one or more wireless services without authorization. The method may include configuring a vehicle telematics unit to identify a valet event and initiate a valet mode. It may further include determining a valet event at the telematics unit, and then initiating the valet mode in the vehicle based on the determination. In the valet mode, the one or more wireless services may be temporarily disabled.

According to another embodiment of the invention, there is provided a method of temporarily disabling one or more wireless services to prevent a third-party from using the one or more wireless services without authorization. The method may include configuring a vehicle to enter a valet mode. In the valet mode, one or more wireless services may be disabled, at least temporarily, by a telematics unit. The method may also include a call center receiving a first command associated with the valet event from a vehicle user. The call center may in response remotely initiate the valet mode at the vehicle based on the first command.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a flowchart of one exemplary method of the present disclosure; and

FIG. 3 is a flowchart of another exemplary method of the present disclosure.

### DETAILED DESCRIPTION OF THE ILLUSTRATED EMBODIMENT(S)

The method described below pertains to disabling wireless services in a vehicle when the vehicle is no longer in the possession of a vehicle user such as the vehicle owner or rightful licensee. This may be desirable in multiple circumstances where an authorized third-party (e.g., a bailee) assumes possession of the vehicle. The bailee has the opportunity to use the vehicle (and the vehicle's telematics unit) without the user's authorization to receive wireless services such as streaming music and/or video, browsing the Internet, and using the vehicle as a wireless hotspot. For example, if the bailee uses such wireless services without authorization, the vehicle user may incur unwanted fees associated therewith; in some cases, the vehicle user may not receive a bill for these services for some time after the unauthorized use. Therefore, the method described below discloses a means to temporarily disable the wireless services, as initiated by the vehicle user.

### Communications System—

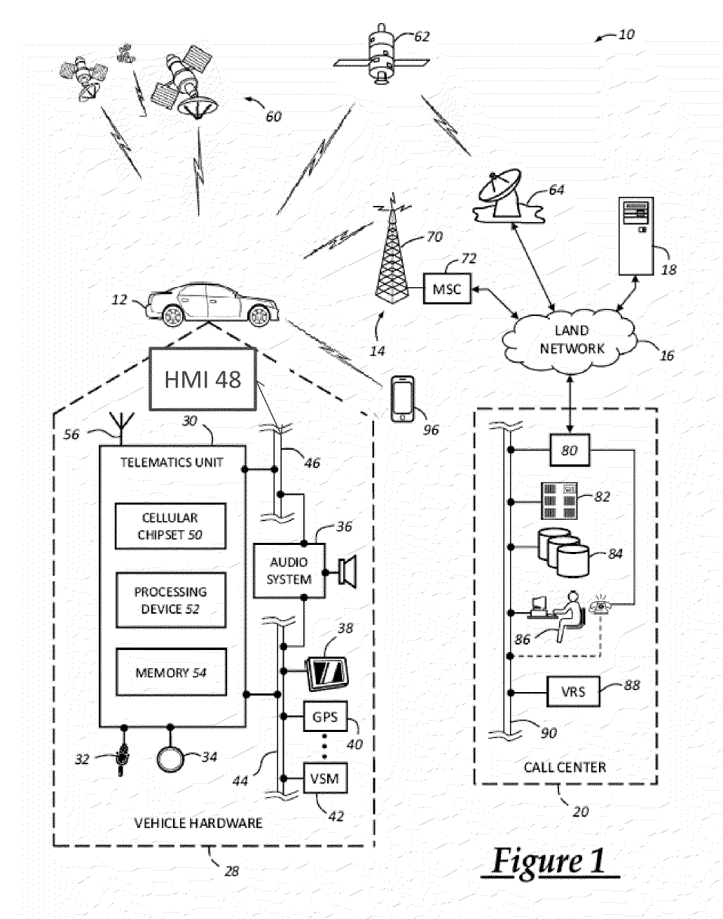

Prior to disclosing the methods for disabling wireless services in the vehicle, with reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle to assist in providing wireless services. The telematics unit may enable wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, etc. Wireless services include the delivery of voice services and the delivery of data services. Data services include control data and content data. Control data may be used control, among other things, various vehicle systems and components. And content data may include, among other things, entertainment and infotainment services. Entertainment and infotainment services include any services including but not limited to streaming video, streaming audio, Internet browsing, e-mail access (web-based e-mail or webmail, POP3 e-mail, IMAP e-mail, MAPI e-mail, etc.), voice over Internet protocol (VoIP), Internet chat participation, Instant Messenger usage, and any other suitable data communications which necessitate cellular data usage and/or which may require access to the vehicle user's confidential or sensitive information (e.g., personal or private information). Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It will be appreciated that GSM or CDMA standards illustrate merely exemplary implementations and other standards are also possible (e.g., LTE). It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, and EDGE. Wireless networking between the vehicle and other networked devices (e.g., a personal wireless device (PWD) 96) can also be carried out using telematics unit 30. For this purpose, telematics unit 30 can be configured to communicate wirelessly according to one or more suitable wireless protocols (e.g., WiMAX), including any short range wireless communication (SRWC) such as Wi-Fi (IEEE 802.11), Wi-Fi Direct, Bluetooth, other Wi-Fi standards such as ZigBee®, wireless infrared transmission, or various combinations thereof. When used for packet-switched data communication such as TCP/IP, the telematics unit can be configured with a static IP address or can set up to automatically receive an assigned IP address from another device on the network such as a router or from a network address server. Thus, it should be appreciated that the telematics unit in some instances may be used as a Wi-Fi hotspot for other electronic devices such as Smart Phones, laptops, netbooks, etc.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

According to at least one embodiment, some of the vehicle electronics 28 may collectively be grouped and/or coupled together as an HMI device 48. For example, in one implementation, the HMI device 48 may include the display 38, the microphone 32, one or more pushbuttons 34, and/or one or more elements of the audio system 36.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

The operating environment may further include one or more handheld communications devices (HCDs) or personal wireless devices (PWDs) 96. The PWD may be an electronic device which may be used to make mobile telephone calls across a wide geographic area where transmissions are facilitated by the wireless carrier system 14 (i.e., when the PWD is connected to the wireless carrier system).

The PWD may further include: hardware, software, and/or firmware enabling cellular telecommunications and communications via short-range wireless communication (e.g., Wi-Fi Direct and Bluetooth) as well as other PWD applications. Such PWD applications may include software applications, which may be preinstalled or installed by the user (or manufacturer) (e.g., having a graphical user interface or GUI). One commercial implementation of a vehicle-PWD application may be RemoteLink™, enabling a vehicle user to communicate with the vehicle 12 and/or control various aspects or functions of the vehicl—e.g., among other things, allowing the user to remotely lock/unlock vehicle doors, turn the vehicle On/Off, check the vehicle tire pressures, fuel level, oil life, etc. RemoteLink™ may also allow the user to connect with the call center 20 or the call center advisor 86 at any time.

The hardware of the PWD 96 may comprise: a display, a keypad (e.g., push button and/or touch screen), a microphone, one or more speakers, motion-detection sensors (such as accelerometers, gyroscopes, etc.), and a camera. In addition to the aforementioned features, modern PWDs may support additional services and/or functionality such as short messaging service (SMS or texts), multimedia messaging service (MMS), email, internet access, as well as business and gaming applications. Non-limiting examples of the PWD 96 include a cellular telephone, a personal digital assistant (PDA), a Smart Phone, a personal laptop computer having two-way communication capabilities, a netbook computer, or any suitable combinations thereof. The PWD 96 may be used inside or outside of a mobile vehicle (such as the vehicle 12 shown in FIG. 1), and may be coupled to the vehicle by wire or wirelessly (e.g., using short range wireless communication). The PWD also may be configured to provide services according to a subscription agreement with a third-party facility or wireless/telephone service provider. It should be appreciated that various service providers may utilize the wireless carrier system and that the service provider of the telematics unit 30 may not necessarily be the same as the service provider of the PWD 96.

The PWD 96 and the vehicle 12 may be used together by a person known as the vehicle user such as the driver. However, the vehicle user does not need to be the driver of the vehicle 12 nor does the vehicle user need to have ownership of the PWD 96 or the vehicle 12 (e.g., the vehicle user may be an owner or a licensee of either or both).

### Method—

Turning now from the operating environment, there is a method described herein for disabling wireless services which may be otherwise available using the telematics unit 30. With respect to providing wireless services using the telematics unit, there may be two modes of operation: a mode where wireless services are available (ON) (i.e., an operative mode) and a mode where wireless services are not available (OFF) (i.e., a valet mode). In the operative mode, various wireless services may be received at the vehicle using the telematics unit 30 such as entertainment and infotainment services, participating in cellular calls, or using the vehicle as a Wi-Fi hotspot (e.g., to name a few services). Skilled artisans will appreciate other wireless services may be received in the operative mode. In the valet mode, all such wireless services may be disabled. Disabling such features may include disabling the presentation of any entertainment or infotainment services (e.g., video, imaging, audio, etc.), disabling the entire telematics unit 30, disabling the cellular chipset 50, and/or disabling any one of a number of other cellular communication functions of the telematics unit; techniques to temporarily disable the wireless services capability of the telematics unit 30 are known.

The valet mode may be useful during various circumstances when possession of the vehicle is assumed by another (or a second possessor). In some instances, the second possessor may be a bailee, a keeper, or any other suitable temporary custodian of the vehicle, such as a valet, a parking attendant, a mechanic, etc. Such secondary possessors may take the vehicle 12 as a bailment and may not have authorization to utilize various vehicle functions, such as receiving wireless services using the telematics unit.

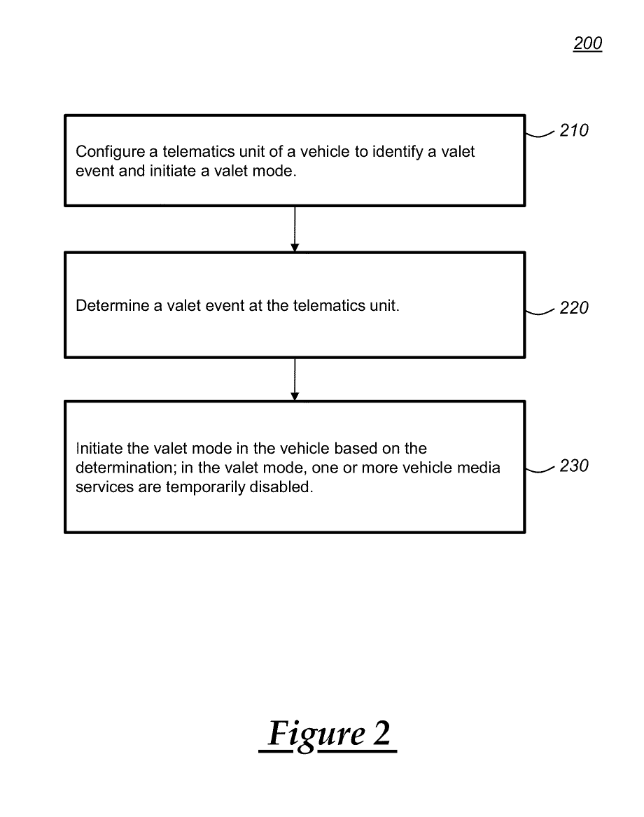

Turning now to FIG. 2, there is shown a method 200 of temporarily disabling a one or more of the vehicle's wireless services to prevent a third-party from using one or more wireless services without authorization. The method begins at step 210 where a telematics unit in a vehicle is configured to identify valet event and then initiate a valet mode based on the identification. The valet event may be a signal, a message, an instruction, a command, or any other suitable means for communicating to the telematics unit that the vehicle user wishes to enter the valet mode. In some implementations, the valet event may also include receipt of an authenticating code. The authenticating code may be used to enter and/or exit the valet mode. The authenticating code may be a security code or personal identification number (PIN) (e.g., a sequence of numbers, letters, special characters, and/or any combination thereof), a secret question, or any other suitable means of authenticating or identifying that the vehicle user is authorized to operate the vehicle 12 and use the wireless services; authenticating codes are known and appreciated by skilled artisans.

Once the vehicle telematics unit is configured, the telematics unit 30 may determine that a valet event has occurred [step 220]. In one implementation, the vehicle user may use the HMI device 48 to send a request or command to the telematics unit to initiate the valet mode. The command may be sent as a result of the user actuating a push/soft button on the HMI device 48. In addition, the user may provide a first authenticating code (e.g., a PIN). Upon receipt of the command and/or the first authenticating code at the telematics unit, the unit 30 may determine whether a valet event has occurred. In one implementation, the command from the HMI device initiates the valet mode and the first authenticating code is stored for later use, more specifically for instances when the first authenticating code must be entered later to place the vehicle in the operative mode (i.e., terminate the valet mode). In another implementation, the first authenticating code is compared with a stored code previously in memory 54 to validate that the user is authorized to initiate the valet mode. The stored code may be programmed by the manufacturer, provided by the call center 20, or preselected by the user (i.e., selected before the user wishes to enter a valet mode).

Once the valet event is determined to have occurred, the telematics unit may initiate the valet mode [step 230]—thereby temporarily disabling all vehicle wireless services. In the valet mode, any services which require cellular or mobile data usage may be temporarily disabled or terminated; optionally, other services may also be disabled. Preventing the usage of wireless services while the vehicle is in possession of the bailee may prevent unauthorized charges to the user's vehicle cellular account (as the vehicle user is likely to be charged for both authorized and unauthorized use); furthermore, in some cases, the vehicle user's privacy may also be protected by disabling wireless services (as some access acquired by an unauthorized user may include access to the user's sensitive or confidential information).

When the vehicle user reenters the vehicle 12 (i.e., when the bailee return the vehicle 12 to the user), the user may then return the vehicle to an operative mode using the HMI device 48, thus ending the valet mode. In one implementation, the vehicle user may actuate the same or a different push/soft button on the HMI device to terminate the valet mode sending a second command to the telematics unit 30. And in some implementations, the user may also provide a second authenticating code. In some implementations, the second authenticating code will be the same as the first authenticating code, and in other implementations, it may be different.

The method 200 may be accomplished by means other than the HMI device 48. For example, the method described in FIG. 2 may also be accomplished using the PWD 96, any portal (such as computer 18) providing access to an Internet web-application, or an interaction with the call center 20.

In implementations using the PWD 96, the first command to initiate the valet mode may be received wirelessly at the telematics unit 30 from the PWD—the PWD having a software application such as RemoteLink™. The PWD may use various channels of communication; e.g., the PWD may communicate wirelessly via SRWC with the telematics unit or the PWD may communicate with the telematics unit via the wireless carrier system 14 or the PWD may communicate with the call center via the wireless carrier system which in turn communicates the first command to the telematics unit 30. Thus in one implementation, the PWD communicates the first command in the form of a data message via a data channel to the call center 20, and the call center 20 merely relays this first command to the vehicle 12. In another implementation, the PWD may communicate by wire with the telematics unit. And skilled artisans will appreciate other means by which the PWD may so communicate. In implementations having the first authenticating code, the code may also be communicated by the PWD. Similarly, to terminate the valet mode, the PWD 96 may also communicate the second command and/or the second authenticating code.

In implementations using an Internet web-application, the first and/or second commands and the first and/or second authenticating codes may be communicated via any portal such as a computer 18 to the telematics unit 30. For example, the computer 18 may communicate via the land network 16 and the wireless carrier system 14.

In implementations using the call center 20, the vehicle user may communicate with the call center which in turn then sends the first and/or second commands to the vehicle telematics unit 30. The communication may include a verbal command or request made using any telephonic means such as the PWD 96, plain old telephone service (POTS), or any other suitable communicative means. The user may speak with an advisor 86 or use some other automated call center service. Here again, the user may be required to provide the first and/or second authentication codes to initiate the operative and/or valet modes; in some instances, whether the code(s) are required maybe pre-established (i.e., prior to the time when the user wishes to initiate the valet mode).

It should be appreciated that one means may be used to initiate the valet mode and another means may be used to terminate the valet mode (and return to the operative mode). For example, the HMI device 48 may be used to initiate the valet mode and the PWD 96 may be used to return to the operative mode. It should also be appreciated that use of the HMI device, the PWD, the call center, and Internet portals are merely exemplary and that other embodiments are also possible.

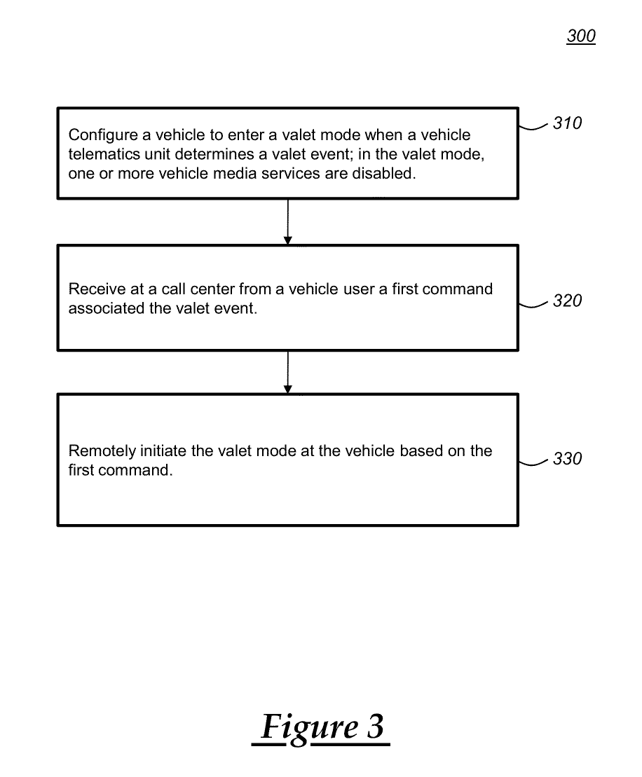

Now turning to FIG. 3, another method 300 is shown of temporarily disabling a vehicle's wireless services to prevent a third-party from using one or more wireless services without authorization. The method begins at step 310 where the vehicle 12 is configured to enter a valet mode. Configuring the vehicle may include ensuring that all devices related to wireless services may be disabled (at least temporarily) upon the receipt of an instruction from the telematics unit 30. And as previously discussed, it may also include configuring the telematics unit to determine a valet event. At step 320, the call center 20 may receive a request or first command from the user of the vehicle to enter the valet mode. This first command may be in the form of a verbal instruction (e.g., to a live advisor or automated call center service) or may be in the form of a command or message from the PWD 96 or a computer 18 (e.g., via an Internet web-application). And at step 330, the call center may remotely initiate the valet mode based upon the first command.

As discussed with respect to FIG. 2, the first command may be accompanied by a first authenticating code; similarly, the call center 20 may also receive a second command and/or a second authenticating code to remotely terminate the valet mode.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of temporarily disabling one or more wireless services to prevent a third-party from using the one or more wireless services without authorization, comprising the steps of:
configuring a telematics unit of a vehicle to identify a valet event and initiate a valet mode;
determining a valet event at the telematics unit; and
initiating the valet mode in the vehicle based on the determination, wherein in the valet mode, one or more wireless services are temporarily disabled.

2. The method of claim 1 wherein the valet event is a first command received from a human machine interface (HMI) device in the vehicle, a call center, a personal wireless device (PWD), or an internet web-application.

3. The method of claim 2 wherein the first command is based upon a request from a vehicle user.

4. The method of claim 3 wherein the request from the vehicle user is sent from at least one of the following: the HMI device, the PWD, or the internet web-application.

5. The method of claim 2 wherein the first command includes a first authenticating code.

6. The method of claim 5 wherein the vehicle remains in the valet mode until a second command is received having a second authenticating code.

7. The method of claim 6 wherein the first authenticating code is the same as the second authenticating code.

8. The method of claim 1 wherein the wireless services includes the delivery of voice services or the delivery of data services.

9. The method of claim 8 wherein the data services include entertainment or infotainment services including one or more of the following: streaming video, streaming audio, internet browsing, email access, voice over internet protocol (VoIP) usage, internet chat usage, or internet messenger usage.

10. The method of claim 1 wherein the third-party is a bailee to a user of the vehicle.

11. A method of temporarily disabling one or more wireless services to prevent a third-party from using the one or more wireless services without authorization, comprising the steps of:
configuring a vehicle to enter a valet mode, wherein the valet mode disables one or more wireless services when a vehicle telematics unit determines a valet event;
receiving at a call center from a user of the vehicle a first command associated the valet event; and
remotely initiating the valet mode at the vehicle based on the first command.

12. The method of claim 11 wherein the first command is received from at least one of the following: a human machine interface (HMI) device in the vehicle, a personal wireless device (PWD), or an internet web-application.

13. The method of claim 12 wherein the first command includes a first authenticating code.

14. The method of claim 13 wherein the vehicle remains in the valet mode until a second command is received having a second authenticating code.

15. The method of claim 14 wherein the first authenticating code is the same as the second authenticating code.

16. The method of claim 11 wherein the wireless services includes the delivery of voice services or the delivery of data services.

17. The method of claim 16 wherein the data services include entertainment or infotainment services including one or more of the following: streaming video, streaming audio, internet browsing, email access, voice over internet protocol (VoIP) usage, internet chat usage, or internet messenger usage.

18. The method of claim 11 wherein the third-party is a bailee to a user of the vehicle.
